(19) United States
(12) Patent Application Publication
(10) Pub. No.: US 2024/0096546 A1
(43) Pub. Date: Mar. 21, 2024

(54) MAGNETIC MEMBER AND METHOD OF MANUFACTURING THE SAME

(71) Applicant: DELTA ELECTRONICS, INC., Taoyuan City (TW)

(72) Inventors: Cai-Li GU, Taoyuan City (TW); Chun-Ching YEN, Taoyuan City (TW); Xiao-Xia YUAN, Taoyuan City (TW); Chih-Ho LAI, Taoyuan City (TW); Shao-Dong ZHANG, Taoyuan City (TW)

(21) Appl. No.: 18/181,534

(22) Filed: Mar. 9, 2023

(30) Foreign Application Priority Data
Sep. 20, 2022 (CN) 202211142656.8

(51) Int. Cl. H01F 27/32; H01F 5/04; H01F 27/24; H01F 27/29

(52) U.S. Cl. CPC H01F 27/325; H01F 5/04; H01F 27/24; H01F 27/29

(57) ABSTRACT

A magnetic member includes a bobbin, a coil and a magnetic core. The bobbin includes a first portion and a second portion. The second portion is connected to the first portion and includes a thermoplastic material. The first portion includes an insulating material that is different from the thermoplastic material. The coil is wound on the first portion of the bobbin and includes a terminal end fixed at the second portion of the bobbin. The magnetic core is disposed on the bobbin and extends through the bobbin.

### RELATED APPLICATIONS

This application claims priority to China Application Serial Number 202211142656.8, filed Sep. 20, 2022, the disclosure of which is incorporated herein by reference in its entirety.

### BACKGROUND

### Technical Field

The present disclosure relates to a magnetic member and a method of manufacturing a magnetic member.

### Description of Related Art

As technology advances, transformers need to provide high-power output in order to meet the requirements of electronic devices, and the diameters of the coils of the transformers have increased accordingly. The increase of coil diameter makes it harder to secure/fix the coils. With the design of the currently available transformers, the coils can only be manually secured, which is both inefficient and costly.

### SUMMARY

In view of the foregoing, one of the objects of the present disclosure is to provide a magnetic member which enables and facilitates automated production.

To achieve the objective stated above, in accordance with an embodiment of the present disclosure, a magnetic member includes a bobbin, a coil and a magnetic core. The bobbin includes a first portion and a second portion. The second portion is connected to the first portion and includes a thermoplastic material. The first portion includes an insulating material that is different from the thermoplastic material. The coil is wound on the first portion of the bobbin and includes a terminal end fixed at the second portion of the bobbin. The magnetic core is disposed on the bobbin and extends through the bobbin.

In one or more embodiments of the present disclosure, the second portion of the bobbin surrounds and contacts the terminal end of the coil.

In one or more embodiments of the present disclosure, the insulating material of the first portion of the bobbin is a thermoset material.

In one or more embodiments of the present disclosure, the first portion of the bobbin includes a first engaging structure. The second portion includes a second engaging structure interlocking with the first engaging structure.

In one or more embodiments of the present disclosure, the first portion of the bobbin includes an extending structure, and the second portion of the bobbin wraps around the extending structure.

In one or more embodiments of the present disclosure, the first portion of the bobbin includes an extending structure. The extending structure has an aperture. The second portion of the bobbin includes a post extending through the aperture and fixedly coupled with the extending structure.

In accordance with an embodiment of the present disclosure, a method of manufacturing a magnetic member includes: providing a bobbin, the bobbin including a first portion and a second portion, the second portion being connected to the first portion and including a thermoplastic material; winding at least one coil on the first portion of the bobbin, and positioning a terminal end of the coil at the second portion of the bobbin; and heating the second portion of the bobbin such that the second portion of the bobbin partially melts and wraps around the terminal end of the coil.

In one or more embodiments of the present disclosure, the step of positioning the terminal end of the coil at the second portion of the bobbin includes positioning the terminal end of the coil in at least one recess of the second portion, and wherein heating the second portion of the bobbin closes the recess and thereby causes the second portion to wrap around the terminal end of the coil.

In one or more embodiments of the present disclosure, the method further includes: clamping the terminal end of the coil with two side surfaces of the recess.

In one or more embodiments of the present disclosure, the second portion of the bobbin includes a first recess and a second recess. The step of heating the second portion of the bobbin includes: contacting, by a heating device, a protruding structure between the first recess and the second recess, such that the protruding structure partially melts and closes the first and second recesses.

In one or more embodiments of the present disclosure, the protruding structure has a concavity. The concavity is located at an end of the protruding structure. The heating device is configured to heat the protruding structure from the concavity.

In one or more embodiments of the present disclosure, the method further includes: before positioning the terminal end of the coil in the recess, shaping the terminal end of the coil such that the terminal end approximates a cylinder.

In one or more embodiments of the present disclosure, the method further includes: combining the first portion and the second portion of the bobbin by means of hot melting.

In one or more embodiments of the present disclosure, the method further includes: combining the first portion and the second portion of the bobbin by interlocking the first portion with the second portion.

In one or more embodiments of the present disclosure, the first portion of the bobbin includes a thermoset material.

In sum, in the magnetic member of the present disclosure, the bobbin includes a first portion for coil winding and a second portion for fixing the terminal end of the coil, in which the second portion includes a thermoplastic material. During the manufacturing of the magnetic member, the terminal end of the coil can be positioned at the second portion of the bobbin (e.g., the terminal end of the coil can be fit into one or more recesses of the second portion), and then the second portion of the bobbin can be heated, such that the second portion of the bobbin partially melts and wraps around the terminal end. The terminal end can be secured at the second portion of the bobbin after the second portion of the bobbin cools down and solidifies. By this arrangement, production of the magnetic member can be automated.

### BRIEF DESCRIPTION OF THE DRAWINGS

To make the objectives, features, advantages, and embodiments of the present disclosure, including those mentioned above and others, more comprehensible, descriptions of the accompanying drawings are provided as follows.

FIGS. 1 and 2 illustrate a front view and a rear view of a magnetic member in accordance with an embodiment of the present disclosure;

FIG. 3 illustrates a cross-sectional view of the bobbin of the magnetic member of FIG. 2 taken along the line segment 2-2′;

FIG. 4 illustrates an exploded view of a magnetic member without coil;

FIG. 5 illustrates an exploded view of the bobbin shown in FIG. 4;

FIG. 6 illustrates a top view of a bobbin in accordance with another embodiment of the present disclosure;

FIG. 7 illustrates a cross-sectional view of the bobbin of FIG. 6 taken along the line segment 6-6′;

FIG. 8 illustrates a top view of a bobbin in accordance with another embodiment of the present disclosure; and

FIG. 9 illustrates a cross-sectional view of the bobbin of FIG. 8 taken along the line segment 8-8′.

### DETAILED DESCRIPTION

For the completeness of the description of the present disclosure, reference is made to the accompanying drawings and the various embodiments described below. Various features in the drawings are not drawn to scale and are provided for illustration purposes only. To provide full understanding of the present disclosure, various practical details will be explained in the following descriptions. However, a person with an ordinary skill in relevant art should realize that the present disclosure can be implemented without one or more of the practical details. Therefore, the present disclosure is not to be limited by these details.

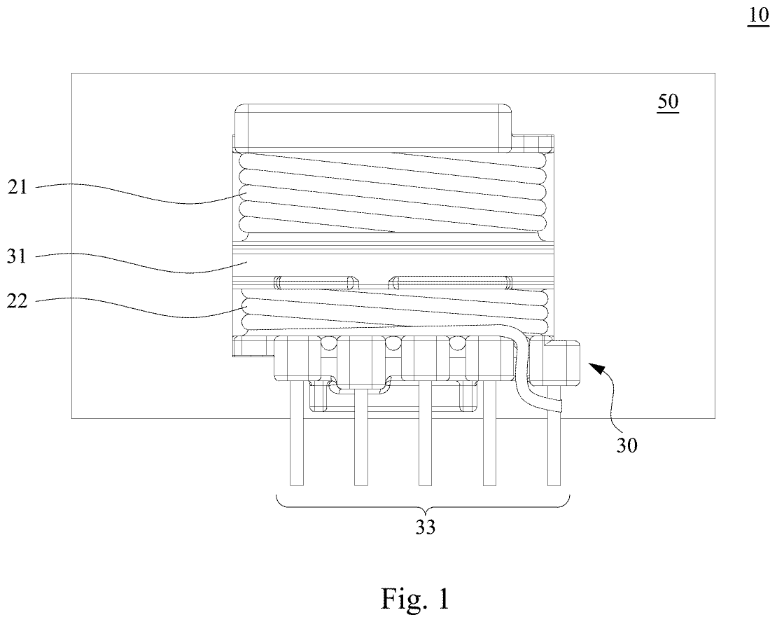

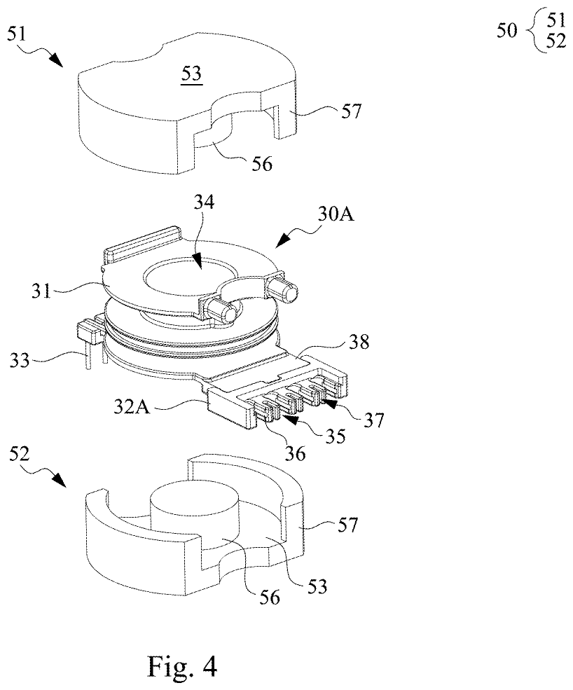

Reference is made to FIG. 1, which illustrates a front view of a magnetic member 10 in accordance with an embodiment of the present disclosure. The magnetic member 10 includes at least one first coil 21, at least one second coil 22, a bobbin 30 and a magnetic core 50. The first coil 21 and the second coil 22 are wound on a first portion 31 of the bobbin 30 and are spaced apart from each other. The first portion 31 of the bobbin 30 includes an insulating material, such as Bakelite. The magnetic core 50 is disposed on the bobbin 30 and extends through the bobbin 30. Specifically, the magnetic core 50 covers the bobbin 30 and extends through a central opening of the bobbin 30 (see FIG. 4).

As shown in FIG. 1, in the present embodiment, the magnetic member 10 is a transformer (in other embodiments, the magnetic member can be an inductive component). The first coil 21 is the secondary-side coil, and the second coil 22 is the primary-side coil. The first coil 21 can include a multi-strand wire, so that the first coil 21 can carry larger current. The bobbin 30 further includes a plurality of conductive pins 33 fixedly mounted on the first portion 31. In the present embodiment, the conductive pins 33 are disposed on opposite sides of the first portion 31. The at least one second coil 22 is connected to the conductive pins 33 (FIG. 1 only schematically shows the second coil 22 connected to one of the conductive pins 33, but other conductive pins 33 can be connected with the second coil 22 as well).

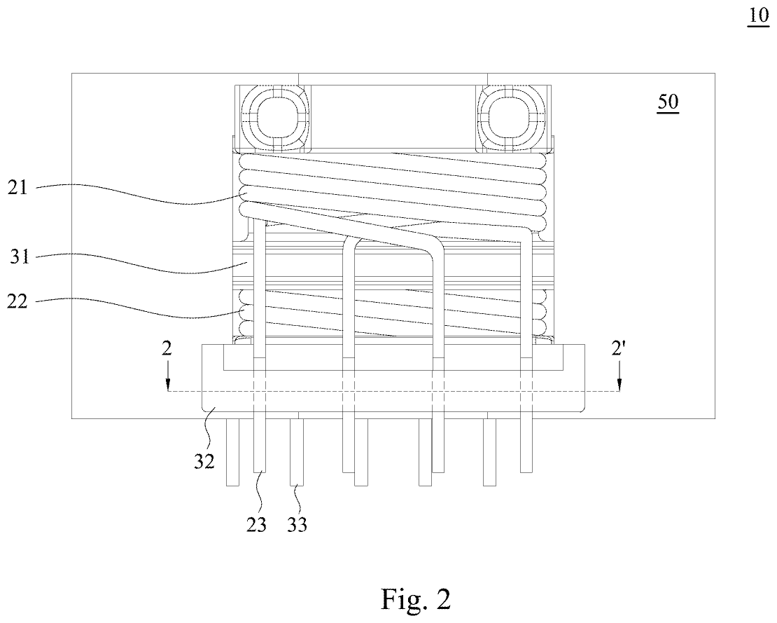

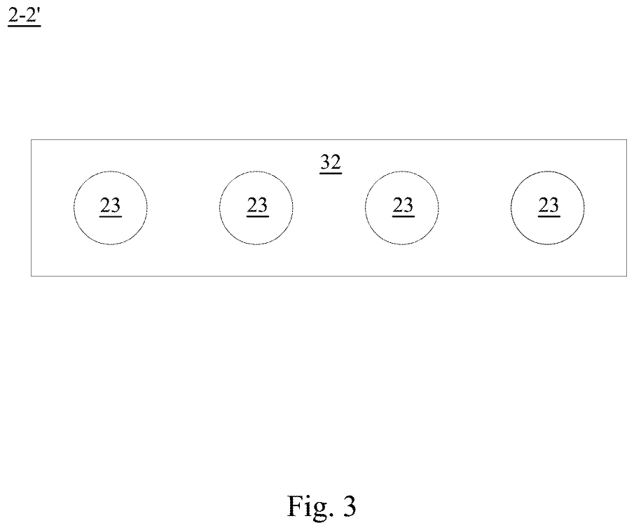

Reference is made to FIGS. 2 and 3. FIG. 2 illustrates a rear view of the magnetic member 10 shown in FIG. 1, and FIG. 3 illustrates a cross-sectional view of the bobbin 30 of the magnetic member 10 of FIG. 2 taken along the line segment 2-2′. The bobbin 30 further includes a second portion 32 connected to the first portion 31. In the present embodiment, the second portion 32 is disposed on a side of the first portion 31. In other embodiments, the second portion 32 can be disposed on opposite sides of the first portion 31. The second portion 32 of the bobbin 30 includes a thermoplastic material that is different from the insulating material of the first portion 31. The first coil 21 includes at least one terminal end 23 (i.e., the portion of the first coil 21 where conductive material is exposed) fixed at the second portion 32 of the bobbin 30. In some embodiments, the second portion 32 of the bobbin 30 wraps around the terminal end 23 of the first coil 21. For example, the second portion 32 of the bobbin 30 can surround the terminal end 23 and contact the outer peripheral surface of the terminal end 23.

In the magnetic member 10 of the present disclosure, the bobbin 30 includes the second portion 32 which serves to fix the terminal end 23 of the first coil 21 and includes a thermoplastic material. During the manufacturing of the magnetic member 10, the terminal end 23 of the first coil 21 can be positioned at the second portion 32 of the bobbin 30, and the second portion 32 of the bobbin 30 is heated, such that the second portion 32 of the bobbin 30 partially melts and wraps around the terminal end 23. The terminal end 23 can be fixedly held at the second portion 32 of the bobbin 30 after the second portion 32 of the bobbin 30 cools down and solidifies. The positioning of the terminal end 23 and the subsequent heating of the second portion 32 of the bobbin 30 can both be performed by machines, such that the manufacturing of the magnetic member 10 can be highly automated or fully automated. As a result, labor cost can be saved and production efficiency can be improved.

On the other hand, the first portion 31 of the bobbin 30 is provided for the winding of the first coil 21 and the second coil 22. Using a hot-melting process to fix the first coil 21 and the second coil 22 on the first portion 31 of the bobbin 30 is not necessary, and thus the first portion 31 of the bobbin 30 can include a thermoset material. In practice, the procedure of winding the first coil 21 and the second coil 22 on the first portion 31 of the bobbin 30 can also be automated.

Reference is made to FIG. 4, which illustrates an exploded view of a magnetic member without coil. In some embodiments, before carrying out a hot-melting process to form the second portion 32 wrapping around the terminal end 23, the second portion 32A of the bobbin 30A has one or more recesses 35. The recesses 35 are configured to receive the at least one terminal end 23 of the at least one first coil 21 (see FIG. 2). During the manufacturing of the magnetic member 10, the terminal end 23 of the first coil 21 can be positioned in the recesses 35 of the second portion 32A of the bobbin 30A, and then the second portion 32A of the bobbin 30A is heated, such that the recesses 35 are closed. As a result, the terminal end 23 would be wrapped around and fixedly held by the second portion 32 of the bobbin 30 as illustrated in FIG. 3.

As shown in FIG. 4, in some embodiments, at least one of the recesses 35 has a preset width that is smaller than a diameter of the terminal end 23 (see FIG. 2). To force the terminal end 23 into said recess 35, an external force needs to applied to the terminal end 23. Due to the dimensional difference between said recess 35 and the terminal end 23, after the terminal end 23 is forced into said recess 35, two sides surfaces of said recess 35 clamp the terminal end 23 of the first coil 21. As the terminal end 23 is clamped, inadvertent displacement of the terminal end 23 can be prevented to facilitate the subsequent operation of heating the second portion 32A of the bobbin 30A to fix the terminal end 23.

As shown in FIG. 4, in some embodiments, two neighboring recesses 35 are separated by a protruding structure 36. During the manufacturing of the magnetic member 10, a heating device (not depicted) can be configured to contact the protruding structure 36, such that the protruding structure 36 partially melts and closes the recesses 35 next to the protruding structure 36. In some embodiments, after the heating device causes the protruding structure 36 to partially melt, the heating device can be further configured to push the melted portion of the protruding structure 36, such that the melted thermoplastic material extends to the left and the right to close the recesses 35 nearby.

As shown in FIG. 4, in some embodiments, the protruding structure 36 has a concavity 37. The concavity 37 is located at an end of the protruding structure 36. During the manufacturing of the magnetic member 10, the heating device can heat the protruding structure 36 from the concavity 37 (e.g., the heating device can include at least one protruding portion that extends into the concavity 37 and contacts the inner surface of the concavity 37), such that the thermoplastic material around the concavity 37 melts and closes the recesses 35 nearby. On the other hand, as mentioned above, at least one of the recesses 35 can have a preset width that is smaller than the diameter of the terminal end 23, in order to clamp the terminal end 23 to hold the terminal end 23 still. Providing the protruding structure 36 with the concavity 37 can lower the force required to push the terminal end 23 into the recesses 35.

As mentioned above, in embodiments where the magnetic member 10 is a transformer, the first coil 21 is the secondary-side coil, and the secondary-side coil can include a multi-strand wire. Generally speaking, multi-strand wires have a larger variation in diameter and have irregular shapes. In view of said issue, in some embodiments, before the terminal end 23 of the first coil 21 is positioned in the recesses 35 of the second portion 32A, the terminal end 23 is shaped to approximate a cylinder (the cross-section of the terminal end 23 would thus approximate a circular disk), such that the terminal end 23 can more easily fit into the recesses 35.

As shown in FIG. 4, in some embodiments, the magnetic core 50 includes a first magnetic component 51 and a second magnetic component 52. The first magnetic component 51 and the second magnetic component 52 are, for example, E-cores, and each include a planar portion 53, an axial portion 56 and a sidewall portion 57. The planar portions 53 of the first magnetic component 51 and the second magnetic component 52 face the top and the bottom of the first portion 31 of the bobbin 30A, respectively. The axial portions 56 extend through a central opening 34 of the first portion 31. The sidewall portions 57 face the side surfaces of the first portion 31. The axial portion 56 and the sidewall portion 57 of the first magnetic component 51 are connected to the axial portion 56 and the sidewall portion 57 of the second magnetic component 52, respectively, and thereby create a closed magnetic path.

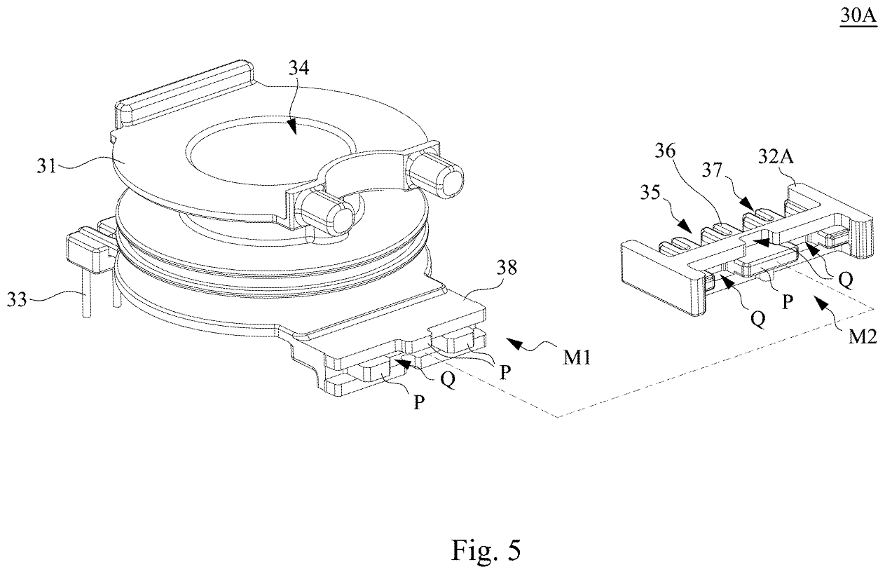

Reference is made to FIG. 5, which illustrates an exploded view of the bobbin 30A shown in FIG. 4. In some embodiments, the first portion 31 and the second portion 32A of the bobbin 30A can be combined by interlocking the first portion 31 with the second portion 32A. Specifically, the first portion 31 of the bobbin 30A includes a first engaging structure M1, and the second portion 32A includes a second engaging structure M2 interlocking with the first engaging structure M1. The first engaging structure M1 can include one or more protrusions P configured to be inserted into one or more depressions Q of the second engaging structure M2 provided at corresponding locations. The first engaging structure M1 can also include one or more depressions Q configured to receive one or more protrusions P of the second engaging structure M2 provided at corresponding locations. In some embodiments, the first portion 31 of the bobbin 30A includes an extending structure 38, and the first engaging structure M1 are provided on an end surface of the extending structure 38.

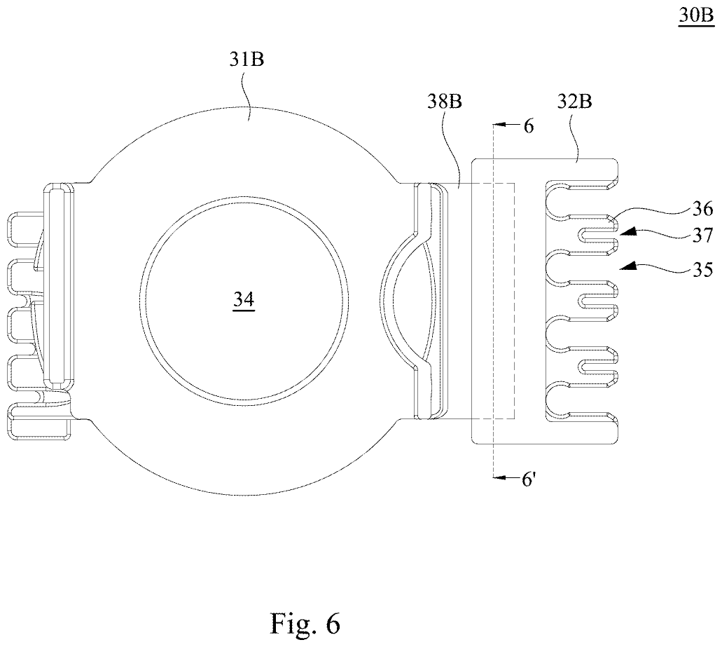

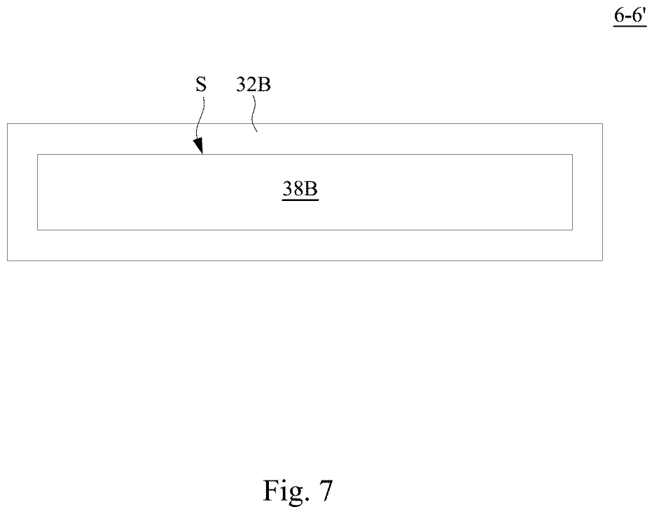

Reference is made to FIGS. 6 and 7. The present embodiment differs from the previous embodiment is that the first portion 31B and the second portion 32B of the bobbin 30B of the present embodiment are combined by means of hot-melting. Specifically, in the present embodiment, the second portion 32B of the bobbin 30B is first fit over the extending structure 38B of the first portion 31B, and then the second portion 32B, which includes thermoplastic material, can be heated at its edge, such that the second portion 32B partially melts and wraps the extending structure 38B. After the second portion 32B cools down and solidifies, the second portion 32B would be fixedly coupled with the extending structure 38B. In some embodiments, the extending structure 38B can have one or more grooves (not depicted). After being heated, the second portion 32B partially melts and flows into the grooves. When the second portion 32B cools down and solidifies, the second portion 32B would fixedly engage with the grooves.

The second portion 32B of the bobbin 30B can be arranged to completely cover a peripheral surface S of the extending structure 38B as illustrated in FIG. 7, but the present disclosure is not limited thereto. In other embodiments, the second portion 32B of the bobbin 30B can cover a part of the peripheral surface S of the extending structure 38B and expose another part of the peripheral surface S of the extending structure 38B, which can still allow the second portion 32B to fixedly join with the extending structure 38B.

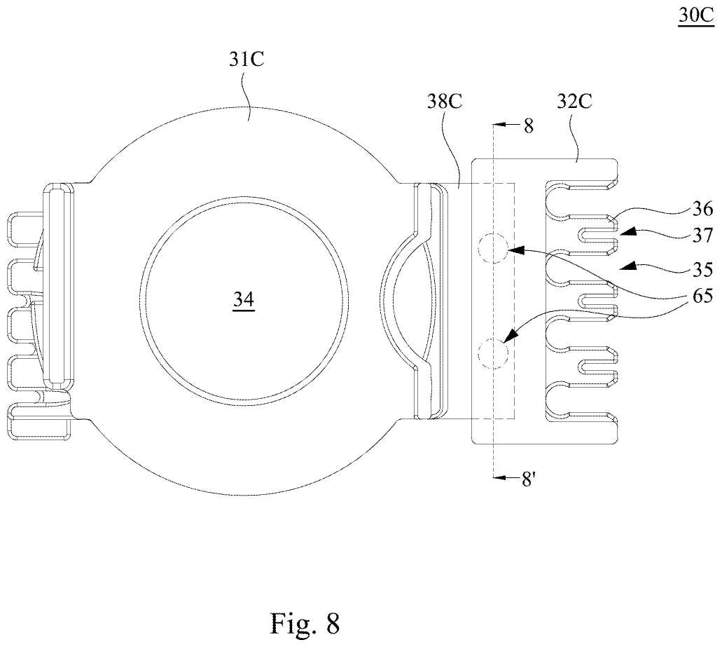

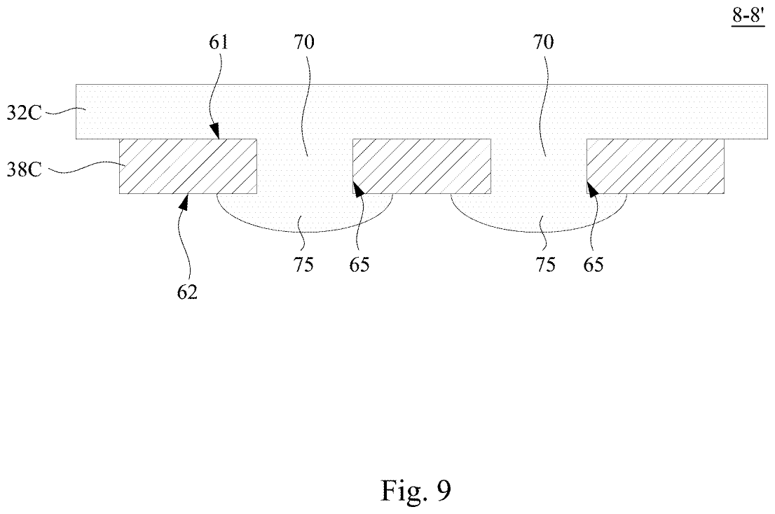

Reference is made to FIGS. 8 and 9. In the present embodiment, the first portion 31C and the second portion 32C of the bobbin 30C are also combined by means of hot-melting, but in a way different from the previous embodiment. Specifically, in the present embodiment, the extending structure 38C of the first portion 31C of the bobbin 30C has a first surface 61, a second surface 62 opposite to the first surface 61, and at least one aperture 65 extending from the first surface 61 to the second surface 62. The second portion 32C of the bobbin 30C rests against the first surface 61 of the extending structure 38C and includes at least one post 70. The post 70 extends through the aperture 65, and the post 70 has a head portion 75 on its outer end. The head portion 75 has a width greater than the width of the aperture 65, such that the second portion 32C can be fixedly coupled with the extending structure 38C.

The head portion 75 is formed by heating the second portion 32C which includes thermoplastic material. Before the head portion 75 is formed, the width of the entire post is less than the width of the aperture 65, such that the post can pass through the aperture 65. After the post is passed through the aperture 65, a portion of the post that extends out of the aperture 65 can be heated, such that the post partially melts and forms the head portion 75 of greater width than the aperture 65.

In sum, in the magnetic member of the present disclosure, the bobbin includes a first portion for coil winding and a second portion for fixing the terminal end of the coil, in which the second portion includes a thermoplastic material. During the manufacturing of the magnetic member, the terminal end of the coil can be positioned at the second portion of the bobbin (e.g., the terminal end of the coil can be fit into one or more recesses of the second portion), and then the second portion of the bobbin can be heated, such that the second portion of the bobbin partially melts and wraps around the terminal end. The terminal end can be secured at the second portion of the bobbin after the second portion of the bobbin cools down and solidifies. By this arrangement, production of the magnetic member can be automated.

Although the present disclosure has been described by way of the exemplary embodiments above, the present disclosure is not to be limited to those embodiments. Any person skilled in the art can make various changes and modifications without departing from the spirit and the scope of the present disclosure. Therefore, the protective scope of the present disclosure shall be the scope of the claims as attached.

What is claimed is:

1. A magnetic member, comprising:
a bobbin comprising a first portion and a second portion, wherein the second portion is connected to the first portion and comprises a thermoplastic material, wherein the first portion comprises an insulating material different from the thermoplastic material;
a coil wound on the first portion of the bobbin and comprising a terminal end, the terminal end being fixed at the second portion of the bobbin; and
a magnetic core disposed on the bobbin and extending through the bobbin.

2. The magnetic member of claim 1, wherein the second portion of the bobbin surrounds and contacts the terminal end of the coil.

3. The magnetic member of claim 1, wherein the insulating material of the first portion of the bobbin is a thermoset material.

4. The magnetic member of claim 1, wherein the first portion of the bobbin comprises a first engaging structure, the second portion comprises a second engaging structure interlocking with the first engaging structure.

5. The magnetic member of claim 1, wherein the first portion of the bobbin comprises an extending structure, and the second portion of the bobbin wraps around the extending structure.

6. The magnetic member of claim 1, wherein the first portion of the bobbin comprises an extending structure, the extending structure has an aperture, the second portion of the bobbin comprises a post extending through the aperture and fixedly coupled with the extending structure.

7. A method of manufacturing a magnetic member, comprising:
providing a bobbin, the bobbin comprising a first portion and a second portion, the second portion being connected to the first portion and comprising a thermoplastic material;
winding at least one coil on the first portion of the bobbin, and positioning a terminal end of the coil at the second portion of the bobbin; and
heating the second portion of the bobbin such that the second portion of the bobbin partially melts and wraps around the terminal end of the coil.

8. The method of claim 7, wherein the step of positioning the terminal end of the coil at the second portion of the bobbin comprises positioning the terminal end of the coil in at least one recess of the second portion, and wherein heating the second portion of the bobbin closes the recess and thereby causes the second portion to wrap around the terminal end of the coil.

9. The method of claim 8, further comprising: clamping the terminal end of the coil with two side surfaces of the recess.

10. The method of claim 8, wherein the at least one recess comprises a first recess and a second recess, and wherein the step of heating the second portion of the bobbin comprises: contacting, by a heating device, a protruding structure between the first recess and the second recess, such that the protruding structure partially melts and closes the first and second recesses.

11. The method of claim 10, wherein the protruding structure has a concavity, the concavity is located at an end of the protruding structure, and wherein the heating device is configured to heat the protruding structure from the concavity.

12. The method of claim 8, further comprising: before positioning the terminal end of the coil in the recess, shaping the terminal end of the coil such that the terminal end approximates a cylinder.

13. The method of claim 7, further comprising: combining the first portion and the second portion of the bobbin by means of hot melting.

14. The method of claim 7, further comprising: combining the first portion and the second portion of the bobbin by interlocking the first portion with the second portion.

15. The method of claim 7, wherein the first portion of the bobbin comprises a thermoset material.
